(19) United States
(12) Patent Application Publication
(10) Pub. No.: US 2007/0054057 A1
(43) Pub. Date: Mar. 8, 2007

(54) Durable bn mould separating agents for the die casting of non-ferrous metals

(75) Inventors: Peter Matje, Ottobeuren (DE); Martin Engler, Kempten (DE); Karl Schwetz, Sulzberg (DE); Mesut Aslan, Hoheischweiler (DE); Robert Drumm, Saarbrucken (DE); Klaus Endres, Homburg (DE); Hareesh Nair, Kerala (IN); Bernd Reinhard, Merzig-Brotdorf (DE); Helmut Schmidt, Saarbrucken (DE)

Correspondence Address: NATH & ASSOCIATES, 112 South West Street, Alexandria, VA, 22314, US

(73) Assignee: ESK CERAMICS GMBH & CO. KG, Kempten (DE)

(21) Appl. No.: 10/560,113

(22) PCT Filed: Jun. 11, 2004
(86) PCT No.: PCT/EP04/06328

§ 371 Date: Nov. 8, 2006

(30) Foreign Application Priority Data
Jun. 13, 2003 (DE) 103 26 769.7

(51) Int. Cl. B28B 7/36; B05D 5/00; B05D 1/18; B05D 1/28

(52) U.S. Cl. 427/421.1; 106/38.22; 427/443.2; 427/429; 427/435

(57) ABSTRACT

The invention relates to corrosion-resistant, temperature-stable, durable mould release layers, suitable for the die casting of non-ferrous metals, comprising boron nitride and slips for production thereof, a method for production of the slips, a method for production of the mould release layers and the use of the mould release layers.

The invention relates to corrosion-resistant, thermally stable, durable mold release layers suitable for the pressure diecasting of nonferrous metals and comprising boron nitride, and also to sizes for their production, to a process for producing the sizes, to a process for producing the mold release layers and to the use of the mold release layers.

Boron nitride is a material which has been known for some time and whose crystal structure is similar to that of graphite. Like graphite, it has lower wettability compared to many substances, for example silicatic melts or else metal melts. There have therefore been many investigations on nonadhering layers based on boron nitride in order to utilize them for casting processes. However, the problem with this utilization is that it is not possible to apply boron nitride in substance to molds, especially of relatively complex nature, in a durable manner. Sintering application of boron nitride is prevented by its high sintering temperature. In addition, it is required to apply these layers in a very impervious manner, so that melts cannot penetrate into pores, which would lead to increased adhesion. There have therefore been many attempts to employ binders on an inorganic basis, into which the boron nitride has been bonded. In order to survive the temperatures which occur, for example, in the course of metal diecasting, these binders have to be virtually entirely inorganic, since organic binders are decomposed or pyrolized. A disadvantage of these inorganic binders is, when they form impervious layers, that they can cover the boron nitride particles and thus reduce or entirely nullify the antiadhesive power of the boron nitride. This can barely be prevented, since the binders according to the prior art, for example aluminum phosphates, other phosphates or silicates, require a kind of melt flow to become impervious, which drastically reduces the antiadhesive action of the boron nitride and the binders can thus react to the liquid metal, which can lead to adhesion of the casting on the release layer.

Complex, thin-wall components made of nonferrous metals (aluminum, zinc, brass, magnesium) are currently usually produced with pressure diecasting processes. Metal melts are compressed by the application of pressure into the usually multipart molds. These mold parts are usually manufactured from high tensile strength steel.

The mold interiors which come into contact with the partly molten (semisolid or thixoforming) or molten metals have to be provided with release layers in order to prevent corrosion of the mold wall by the liquid metal, to achieve easy demolding by sliding and lubricating action, to prevent adhesion of the casting (welding) by barrier formation, and to ensure support of the metal flux by extending the flow paths.

Important requirements on the release agent are that no solid residues or solid cracking products are left behind on the mold surface, the work piece surface or in the casting, that they do not lead to a further increase in the gas content (gaseous cracking products) in the casting, that the cracking products released do not contain any dangerous or toxic substances and that they do not lead to any adverse influence on the surface properties and mechanical properties of the castings.

Modern mold release agents are subdivided into two large groups, firstly liquid mold release agents in the form of aqueous or water-soluble or organic (water-insoluble) mold release agents, and secondly the group of pulverulent agglomerated dry release agents. The organic mold release agents used are silicone oils, nonpolar polyolefins, fats, synthetic or natural oils or waxes, for example mineral, vegetable or animal oils or waxes, carboxylic acids, organic metal salts, fatty acid esters, and many more.

For the precision casting of iron or steels, for example, ZrO₂ or a mixture of ZrO₂ with Al₂O₃ is used as a release agent in combination with alkali metal silicates. The mold release systems commercially available on the market to date, comprising inorganic release agents, in nearly all cases comprise hexagonal boron nitride (BN), MOS₂ or graphite as inorganic mold release agents in combination with Al₂O₃, alkali metal and alkaline earth metal silicates, and, in some cases, also clays, as described, for example, in U.S. Pat. No. 5,026,422 or U.S. Pat. No. 5,007,962. In addition to the organic release agents, inorganic release agents such as graphite, boron nitride, mica, talc, molybdenum disulfide, molybdenum diselenide, rare earth fluorides, etc. also find use in pressure diecasting, as described, for example, in US 2001/0031707 A1, U.S. Pat. No. 3,830,280 or U.S. Pat. No. 5,076,339.

JP 57168745 claims a mold release agent for the casting of aluminum in metallic dies, which is said to have good film formation and good corrosion properties with respect to liquid aluminum. The composition comprises boron nitride, mica, talc, vermiculite and organic water-soluble binders (CMC).

To improve the wetting and film formation of the liquid mold release agents, surface-active substances (surfactants, emulsifiers) and defoamers are often used. Especially in the case of the water-based release agents, stabilizers, for example preservatives, and corrosion protectants have to be used. Examples of such release agents can be found in different patents (EP 0 585 128 B1, DE 100 05 187 C2, JP 2001-259787 A, U.S. Pat. No. 5,378,270).

U.S. Pat. No. 6,460,602 claims a process for producing magnesium components, in which, for example, BN is applied in combination with soaps or waxes, and also water or oils, to surfaces of pressure diecasting molds, the intention of which is to distinctly increase the lifetime of the molds. The BN coating reduces the corrosion of the mold steel by the liquid metal. However, the release agent has to be applied again after 10 shots in each case. This allowed the lifetimes of the molds to be distinctly increased, since the use of BN is intended to distinctly reduce the corrosive attack of magnesium.

The application of the liquid mold release agents is afflicted with problems, some of them significant. After each casting operation or after the removal of the casting, the hot mold wall is supplied at temperatures, for example, in the range between 200-300° C. with the release agent, preferably by spray application. Owing to the hot die surface, there is rapid evaporation of the solvent, as a result of which only some of the release agent sprayed on (Leidenfrost phenomenon) remains on the surface. With entry of the metal melts, usually at several hundred Celsius, the organic fraction of the release agents is thermally decomposed and forms a gas cushion between die wall and casting metal. Although this gas cushion leads to a desired lengthening of the casting paths through the insulating action, this dissolves large amounts of gas in the workpiece. These dissolved gases can lead to the formation of pores and thus to an adverse influence on the mechanical properties of the casting. In the case of aluminum, the dissolved gases distinctly worsen the welding properties or prevent suitability for welding. To solve these problems, one solution has been to evacuate the molds before charging with the metal melts and secondly to constantly increase the pressure in the course of diecasting (150 MPa). Moreover, the fraction of thermally decomposable constituents in the release agent was reduced as far as possible. Although the use of vacuum (evacuation of the die cavity) before the casting process reduces the amount of gas incorporated in the casting, full prevention is not possible. The increase in the pressure in the course of shaping leads to a reduction in the gas pores but their internal pressure thus increases and a blister test (hot age-hardening) can result in the formation of expanded regions in the surface of castings.

Cyclic stress on the mold surface by the application of sizes which preferably comprise water as a solvent additionally greatly increases the risk of formation of firing cracks and thus restricts the lifetime of the molds. Furthermore, the cyclic application results in considerable pollution of the environment by, and exposure of the personnel to, the unutilized fraction of release agent and also the decomposition products of the organic fractions. The reduction in the thermally decomposable fractions by use of inorganic release agents has the advantage that they do not decompose under the action of the high temperatures, but these release agents, in the case of incorporation into the workpiece, can lead to an adverse influence on the surface properties of the castings, for example discolorations, worsening of the wettability or coatability, or to defects in the casting interior.

The use of inorganic release agents becomes problematic in the event of incomplete decomposition of the organic fractions, which can then lead to firmly adhering baked-on material on the die surfaces. Especially in the case of production of complex thin-wall components, this baked-on material is disadvantageous. The use of dry particulate release agents, as described in the patents DE 39 17 726 or U.S. Pat. No. 6,291,407, entails the development of specific application technology in order to ensure thin homogeneous layers on the complex mold interiors, as described in the patents U.S. Pat. No. 5,662,156, U.S. Pat. No. 5,076,339, DE 100 41 309 or DE 4313961 C2. The release agents are adhered to the metallic die surfaces by use of higher-melting organic components in these particulate release agents, for example waxes or polymers which in turn decompose thermally on contact with the casting metal. The dry release agents thus have to be applied again after each shot or casting process.

One solution to the above problems arises from the bonding of inorganic release agents, for example boron nitride, graphite, mica, talc, silicon nitride, molybdenum sulfide, ZrO₂, Al₂O₃, in a durable and thermally stable manner to the surfaces of the mold walls. One means of applying durable release layers to steels is that of surface finishing processes such as CVD and PVD processes which are used to produce hard substance layers. In the CVD process, however, comparatively high substrate temperatures are needed, which at at least 900° C. are distinctly above the tempering temperatures of the molding steels. In the PVD process, distinctly lower temperatures of 300-500° C. are required. By means of specific plasma processes, TiN, TiC and TiB₂/TiN layers have been obtained on pressure diecasting molds. Some of the layers had very high hardnesses (HK_{0.005} 325-3300). The lifetime of the molds was greatly increased by the factor of 30-80 and the use of the release agents reduced by 97% to approx. 1% in the size. (Rie, Gebauer, Pfohl, Galvanotechnik 89, 1998 No. 10 3380-3388). It was not possible to entirely dispense with release agent. However, these coating processes are not trivial particularly for complex large-volume moldings (molds), since they require great experience and a high level of apparatus complexity. The molds are preferably coated at an external toll coating company after complicated cleaning.

A further means of producing durable release layers is described in the international patent application WO 2000/056481. In this case, impervious and/or porous ceramic release layers with thicknesses of 250-400 μm are applied by means of thermal spraying to mold surfaces. The inorganic release agents preferably have very high melting points and can therefore not be sintered with the usually metallic mold material owing to the high temperatures needed for this purpose. To attach inorganic release agents to the usually metallic mold walls, corrosion-resistant and thermally stable high-temperature binding phases are therefore necessary.

For the precision casting of iron or steels, the release agents used are, for example, ZrO₂ or ZrO₂/Al₂O₃ mixtures. For CaO-stabilized ZrO₂ release layers on ceramic substrates, graphite crucibles and metals, etc., an alkali metal silicate is specified as a binder. In this case too, the content of binder is only a few percent based on the inorganic release agent fraction. For the production of glassware, for the protection of the metallic molds according to U.S. Pat. No. 4,039,377, graphite/BN mixtures with combinations of water-soluble silicatic and phosphatic binders are used. This produces release layers with thickness up to 2 millimeters.

The recently published patent U.S. Pat. No. 6,409,813 describes, for the continuous production of glass, BN release layers with an oxidic fraction of 65-95% by weight and also a BN fraction of 5-35% by weight, in each case after calcination, with binders based on Al₂O₃ or stabilized ZrO₂, which give rise to impervious layers on metallic substrates at temperatures of from at least 500 to 550° C., in which the BN is fully surrounded by the oxidic phase. The oxidic binder phase is produced by means of precipitations from salts or alkoxides. The BN particles should be less than 5 μm. This is said to considerably increase the lifetimes of the metallic dies and molds.

U.S. Pat. No. 6,051,058 describes the production of BN protective layers with thicknesses of from 0.2 to 0.7 mm on refractory materials for the continuous casting of steels. In this case, BN at 20-50% by weight is bound to the refractory material with the aid of high-temperature binders in the form of an aqueous coating solution based on metal oxides of the groups of ZrO₂, zirconium silicates, Al₂O₃, SiO₂ and aluminum phosphates.

The German patent application DE 196 47 368 A1 describes a process for producing thermally stable composite materials with a silicatic high-temperature binder phase. This binder phase enables the production of thermally stable material composites. In one example, core sands for foundry purposes are bound by the silicatic binder. In another example of this patent, a thermally stable molding was produced from a composite composed of 85% by weight of BN and 15% by weight of a binder phase which consists of the silicatic binder phase and also nanodisperse ZrO₂ fractions. Even though, for example, the temperatures employed in aluminum pressure diecasting are well below the transformation range of SiO₂, and even though the binder has high shrinkage on compaction of these layers, these binders did achieve BN layers which, in addition to adhesion on the substrate, also have a certain antiadhesive action against the casting metal, but the binders described in DE 196 47 368 A1 cannot reliably prevent the penetration of metal melt into the layer, especially in the case of pressure diecasting. It has been found that, even though the boron nitride cores are bonded to one another with this binder and thus adhesion to one another and to the substrate forms, as a result of which mechanical properties are achieved which already survive standard pressure diecasting, the cores are nevertheless not fully coated and their antiadhesive action is retained. Although DE 196 47 368 A1 includes the information that boron nitride can be bonded with the binders described there, it is, as already mentioned, not possible with the formulations described there, as in-house investigations have shown, to obtain a layer on diecasting molds which is stable to pressure diecasting. This is because these layers do not have sufficient adhesion of the BN particles in the layer or on the metal surface. In addition, these layers still have excessively high porosities and relatively rough surfaces which lead, in the event of pressurization of the metal melt, to infiltration in the surface and thus form-fitting connection between release layer and casting, which in turn leads to destruction of the release layer on removal of the casting. Although an increase in the binder content led to an improvement in the adhesion and reduction in the porosity with simultaneously high deterioration in the wetting behavior, so that the aluminum adheres strongly to the layer in wetting and corrosion experiments and can only be removed again forcibly with destruction of the release layer.

It is thus an object of the present invention to provide durable mold release layers with inorganic release agents for the pressure diecasting of nonferrous metals, which ensure relatively impervious, smooth mold release layers with high adhesion strength and cut resistance (adhesion to the mold and cohesion to one another) on the usually steel diecasting molds, are not wetted by the particular metal melts, do not have any corrosion as a result of the liquid metal, have lubrication properties in spite of durable attachment in the case of complex mold geometries, do not have to be applied cyclically after each shaping process but rather only at certain predefined time intervals (numbers of shots), allow repair of local damage of the release layers, can be applied by means of common coating techniques (spraying, dipping, brushing, rolling, knife-coating, spin-coating), do not release any further gaseous decomposition products after the thermal compaction, are thermally attached or compacted at temperatures less than 600° C. and possibly obtained by the metal melt itself (in situ), and their organic fractions necessarily present do not constitute any great pollution of the environment in relation to amount and level of hazard in the course of application and the subsequent thermal compaction.

Surprisingly, this object has been achieved by using refractory nanoscale binders as a binder phase for boron nitride.

The invention provides a size for producing a mold release layer with long-term stability, comprising
A) an inorganic binder which comprises colloidal inorganic particles based on silicon oxide, zirconium oxide or aluminum oxide or boehmite or mixtures thereof, additional inorganic fillers selected from the group comprising SiO₂, TiO₂, ZrO₂, Al₂O₃, AlOOH, Y₂O₃, CeO₂, SnO₂, iron oxides and carbon, and also optionally further additives, where
   i) in the case of a binder comprising colloidal inorganic particles based on silicon oxide, the binder further comprises one or more silanes of the general formula (1):
      Rₓ—Si-A₄₋ₓ (1)
      in which
      A are each independently hydrolytically eliminable groups selected from the group comprising hydrogen, halogens, hydroxyl groups and substituted or unsubstituted alkoxy groups having from 2 to 20 carbon atoms, aryloxy groups having from 6 to 22 carbon atoms, alkylaryloxy, acyloxy and alkylcarbonyl groups,
      R are each independently hydrolytically non-eliminable groups selected from the group comprising alkyl groups having from 1 to 20 carbon atoms, alkenyl groups having from 2 to 20 carbon atoms, alkynyl groups having from 2 to 20 carbon atoms, aryl groups having from 6 to 22 carbon atoms, alkaryl and arylalkyl groups,
      x is 0, 1, 2, 3, with the proviso that x≧1 for at least 50% of the amount of silanes,
      and
      substoichiometric amounts of water based on the hydrolyzable groups of the silane component and
      optionally an organic solvent
   or
   ii) in the case of a binder free of colloidal inorganic particles based on silicon oxide, the binder further comprises water as a solvent
   and, under the conditions of the sol-gel process, if appropriate with hydrolysis and condensation, forms a nanocomposite sol,
B) a suspension of boron nitride particles in the organic solvent in the case that the binder (i) is used, or in water in the case that the binder (ii) is used, and
C) an organic solvent in the case that the binder (i) is used, or water in the case that the binder (ii) is used.

The binders present in the inventive sizes have surprisingly shown that they can bind boron nitride particles to give a fixed impervious layer which is not infiltrated by the metal melt and which does not reduce the antiadhesion activity of the boron nitride cores. Useful binders have been found to be nanoscale SiO₂ in conjunction with a specific surface modification, as described in the patent family for the German laid-open specification DE 196 47 368 A1, whose disclosure-content on this subject forms part of the present application.

The optimal dispersion of the BN particles, the partial substitution of silane components, the use of further inorganic filler in the μm range and controlled adjustment of the pH of the sizes as a ready-to-apply coating system consisting of release agent and binder surprisingly enable achievement of the underlying object.

The invention further provides a process for producing a size for producing a mold release layer with long-term stability and comprising
A) an inorganic binder which comprises colloidal inorganic particles based on silicon oxide, zirconium oxide or aluminum oxide or boehmite or mixtures thereof, additional inorganic fillers selected from the group comprising SiO₂, TiO₂, ZrO₂, Al₂O₃, AlOOH, Y₂O₃, CeO₂, SnO₂, iron oxides and carbon, and also optionally further additives, where
   i) in the case of a binder comprising colloidal inorganic particles based on silicon oxide, the binder further comprises one or more silanes of the general formula (1):
      Rₓ—Si-A₄₋ₓ (1)
      in which
      A are each independently hydrolytically eliminable groups selected from the group comprising hydrogen, halogens, hydroxyl groups and substituted or unsubstituted alkoxy groups having from 2 to 20 carbon atoms, aryloxy groups having from 6 to 22 carbon atoms, alkylaryloxy, acyloxy and alkylcarbonyl groups,
      R are each independently hydrolytically non-eliminable groups selected from the group comprising alkyl groups having from 1 to 20 carbon atoms, alkenyl groups having from 2 to 20 carbon atoms, alkynyl groups having from 2 to 20 carbon atoms, aryl groups having from 6 to 22 carbon atoms, alkaryl and arylalkyl groups,
      x is 0, 1, 2, 3, with the proviso that x≧1 for at least 50% of the amount of silanes,
      and
      substoichiometric amounts of water based on the hydrolyzable groups of the silane component and
      optionally an organic solvent
   or
   ii) in the case of a binder free of colloidal inorganic particles based on silicon oxide, the binder further comprises water as a solvent
   and, under the conditions of the sol-gel process, if appropriate with hydrolysis and condensation, forms a nanocomposite sol,
B) a suspension of boron nitride particles in the organic solvent in the case that the binder (i) is used, or in water in the case that the binder (ii) is used,
and
C) an organic solvent in the case that the binder (i) is used, or water in the case that the binder (ii) is used,
   characterized in that boron nitride is dispersed in the solvent and mixed with the inorganic binder.

A preferred embodiment is a process for optimally dispersing the boron nitride powders, with which the BN particles are present in the form of dispersed platelets and the resulting suspensions or sizes have minimum viscosities. It is important that the dispersion of the particles is also retained in the size comprising the binder. This optimal dispersion can surprisingly be obtained by use of organic polymers such as polyvinyl butyrals or polyacrylic acids in the case of alcoholic solvents, or polyvinyl alcohols or polyvinylpyrrolidone in the case of water as a solvent, in combination with a high-performance centrifugal homogenizer as a dispersion unit. For durable attachment and simultaneously good dispersion, controlled adjustment of the pH of the size is also necessary, since the pH of the binder phase resulting from the synthesis is approximately in the order of magnitude of the isoelectric point of the BN and leads to premature precipitation of the BN. Surprisingly, it is possible in a pH range of approx. 3-4 to obtain firstly good attachment (hydrolysis/condensation) and secondly sufficient dispersion/stability of the BN particles.

A distinct increase in the application temperature or delayed setting on the substrate can be achieved by the partial substitution of one silane component (methyltriethoxysilane) by a phenyltriethoxysilane. This enables the application of impervious release layers to molds with increased surface temperatures of over 80° C., which is impossible with the system based on DE 196 47 368.

The organic fractions present with preference do not constitute any great pollution of the environment in relation to amount and level of hazard in the course of application and the subsequent thermal compaction; after the thermal compaction, no further gaseous decomposition products are released.

The temperature for the necessary thermal attachment or compaction of the mold release layer with long-term stability is less than 600° C., i.e. below the tempering temperature, and can under some circumstances even be obtained by virtue of the metal melt itself (in situ).

It was thus possible to obtain, by means of common coating techniques (spraying, dipping, brushing, rolling, knife-coating, spin-coating), smooth, comparatively impervious release layers in a thickness range of from 1 to 50 μm which firstly are not wetted by aluminum and, after aging in liquid aluminum at 750° C. for several hours, do not have any corrosion damage whatsoever. Furthermore, it was possible to increase the layer strength to such an extent that the classification 0-1 was obtained in the cross-cut test (DIN ISO 2409), and no damage to the layer was observed in the subsequent multiple tape test. In the Taber test (DIN 52347), although these layers do exhibit attrition rising linearly with increasing cycle number of 3.6 mg per 100 cycles, layers based on DE 196 47 368, in contrast, cannot be tested by this method with the same BN to binder ratio owing to the strengths being too low and the associated attrition.

The present invention further provides a mold release layer with long-term stability, characterized in that it is obtainable from a size comprising
A) an inorganic binder which comprises colloidal inorganic particles based on silicon oxide, zirconium oxide or aluminum oxide or boehmite or mixtures thereof, additional inorganic fillers selected from the group comprising SiO₂, TiO₂, ZrO₂, Al₂O₃, AlOOH, Y₂O₃, CeO₂, SnO₂, iron oxides and carbon, and also optionally further additives, where
   i) in the case of a binder comprising colloidal inorganic particles based on silicon oxide, the binder further comprises one or more silanes of the general formula (1):
      Rₓ—Si-A₄₋ₓ (1)
      in which
      A are each independently hydrolytically eliminable groups selected from the group comprising hydrogen, halogens, hydroxyl groups and substituted or unsubstituted alkoxy groups having from 2 to 20 carbon atoms, aryloxy groups having from 6 to 22 carbon atoms, alkylaryloxy, acyloxy and alkylcarbonyl groups,
      R are each independently hydrolytically non-eliminable groups selected from the group comprising alkyl groups having from 1 to 20 carbon atoms, alkenyl groups having from 2 to 20 carbon atoms, alkynyl groups having from 2 to 20 carbon atoms, aryl groups having from 6 to 22 carbon atoms, alkaryl and arylalkyl groups,
      x is 0, 1, 2, 3, with the proviso that x≧1 for at least 50% of the amount of silanes,
      and
      substoichiometric amounts of water based on the hydrolyzable groups of the silane component and
      optionally an organic solvent
   or
   ii) in the case of a binder free of colloidal inorganic particles based on silicon oxide, the binder further comprises water as a solvent
   and, under the conditions of the sol-gel process, if appropriate with hydrolysis and condensation, forms a nanocomposite sol,
B) a suspension of boron nitride particles in the organic solvent in the case that the binder (i) is used, or in water in the case that the binder (ii) is used, and
C) an organic solvent in the case that the binder (i) is used, or water in the case that the binder (ii) is used.

The inventive mold release layers permit use in the pressure diecasting range, cycle numbers of more than 30 shots being possible. For repair purposes, this mold release layer system can be applied and compacted at locally restricted sites on an already sized mold, for example by means of airbrush technology or brushes, without significant loss in the properties being observed.

Full removal of the mold release layer by means of a CO₂ coating removal unit is likewise possible.

The invention further provides a process for producing the inventive mold release layer with long-term stability, characterized in that the inventive size is applied to a firmly adhering layer on metal surfaces. The process according to the invention binds preferably hexagonal boron nitride by means of the inventive binder in a durable and thermally stable manner to mold surfaces, for example metals, unalloyed, low-alloy or high-alloy steels, copper or brass.

The release agent BN preferably has a mean particle diameter less than 100 μm, preferably less than 30 μm, more preferably less than 10 μm, and preferably greater than 0.1 μm, more preferably greater than 1 μm. The specific surface area, measured by the BET method, is preferably greater than 1 m²/g and more preferably greater than 5 m²/g. The BN used may contain up to 10% by weight of different impurities and additives. Mention should be made in particular of boric acid, boron trioxide, carbon, alkali metal or alkaline earth metal borates. However, preference is given to using high-purity, extractively washed BN with a purity of at least 98%, preferably 99%. In particular, preference is given to particle sizes of from 2 to 3 μm. The boron nitride preferably has a hexagonal, graphite-like crystal structure. It is more preferred when the boron nitride is present in deagglomerated form in the size.

Based on the abovementioned components of the mold release layer with long-term stability, the solids content of the inorganic binder is preferably between 5 and 95% by weight, preferably from 20 to 80% by weight and more preferably between 30 and 70% by weight.

Specific examples of inorganic fillers are sols and nanoscale powders which preferably have a particle diameter of less than 300 nm, preferentially less than 100 nm and more preferably less than 50 nm, of SiO₂, TiO₂, ZrO₂, Al₂O₃, AlOOH, Y₂O₃, CeO₂, SnO₂, iron oxides, carbon (carbon black, graphite); preference is given to SiO₂, TiO₂, ZrO₂, Y—ZrO₂, Al₂O₃ and AlOOH. Particular preference is given to nanoparticles which preferably have a particle diameter of less than 300 nm, preferably less than 100 nm and more preferably less than 50 nm, of silicon oxides or zirconium oxides or mixtures thereof.

Examples of the hydrolyzable A groups mentioned in formula (1) are hydrogen, halogens (F, Cl, Br and I), alkoxy groups (for example ethoxy, i-propoxy, n-propoxy and butoxy groups), aryloxy groups (for example phenoxy group), alkylaryloxy groups (for example benzyloxy group), acyloxy groups (for example acetoxy, propionyloxy groups) and alkylcarbonyl groups (for example acetyl group).

Particularly preferred radicals are C₂₋₄-alkoxy groups, especially ethoxy group.

The hydrolytically noneliminable R radicals are predominantly selected from the group comprising alkyl radicals (C₁₋₄-alkyl such as methyl, ethyl, propyl and butyl radical), alkenyl radicals (C₂₋₄-alkenyl such as vinyl, 1-propenyl, 2-propenyl and butenyl radical), alkynyl, aryl, alkaryl and arylalkyl radicals.

Particularly preferred radicals are optionally substituted C₁₋₄-alkyl groups, especially methyl or ethyl groups, and optionally substituted C₆₋₁₀-aryl groups, especially phenyl group.

The A and R radicals may each independently have one or more customary substituents, for example halogen, alkoxy, hydroxy, amino and epoxy groups.

It is further preferred that, in the above formula (1), x has the value of 0, 1 or 2 and more preferably the value of 0 or 1. Moreover, preferably at least 60% and in particular at least 70% of the amount have the value x=1.

The inventive high-temperature binder phase can be produced, for example, from pure methyltriethoxysilane (MTEOS) or from mixtures of MTEOS and tetraethoxysilane (TEOS) or MTEOS and phenyltriethoxysilane (PTEOS) and TEOS.

The silanes of the general formula (1) used in accordance with the invention may be used fully or partly in the form of precondensates, i.e. compounds which have formed by partial hydrolysis of the silanes of the formula (1) alone or in a mixture with other hydrolyzable compounds. Such oligomers preferably soluble in the reaction mixture may be straight-chain or cyclic, low molecular weight part-condensates with a degree of condensation of, for example, from about 2 to 100, in particular from 2 to 6.

The amount of water used for hydrolysis and condensation is preferably from 0.1 to 0.9 mol and more preferably from 0.25 to 0.8 mol of water per mole of hydrolyzable groups present.

The hydrolysis and condensation of the silicatic binder phase is carried out under sol-gel conditions in the presence of acidic condensation catalysts, preferably hydrochloric acid, at a pH preferably between 1 and 7, more preferably between 1 and 3. An inventive size is preferably obtained by optimal dispersion of the BN particles, the partial substitution of silane components, the use of further inorganic filler in the μm range and by addition of a certain amount of hydrochloric acid as a catalyst of a controlled hydrolysis or condensation reaction, and also controlled adjustment of the pH of the sizes. The use of condensation catalysts leads to the silane/silica sol mixture which may have been present in biphasic form beforehand becoming monophasic and, owing to the hydrolysis or condensation reactions, attachment of the silanes to the SiO₂ particles or to the metallic substrate or the boron nitride being enabled. Without HCl addition, the result is frequently a biphasic mixture in which the silica sol fraction gels or precipitates out. These investigations were carried out with commercial base- and also acid-stabilized silica sols and always led to the same result.

In addition to the solvent which is formed in the hydrolysis, preference is given to not employing any further solvent, but it is possible if desired to use water, alcoholic solvents (for example ethanol) or other polar, protic and aprotic solvents (tetrahydro-furan, dioxane). When other solvents have to be used, preference is given to ethanol and 1-propanol, 2-propanol, ethylene glycol and derivatives thereof (for example diethylene glycol monoethyl ether, diethylene glycol monobutyl ether).

To produce the binder, it is possible optionally to use further additives in amounts of up to 50% by weight, preferably less than 25% by weight, more preferably less than 10% by weight, for example curing catalysts such as metal salts, and metal alkoxides, organic dispersants and binders such as polyvinyl butyrals, polyethylene glycols, polyethyleneimines, polyvinyl alcohols, polyvinylpyrrolidones, pigments, dyes, oxidic particles, and also glass-forming components (for example boric acid, boric esters, sodium ethoxide, potassium acetate, aluminum sec-butoxide), corrosion protectants and coating assistants.

Any further additional inorganic fillers may be selected from one or more of the substance classes (SiO₂, Al₂O₃, ZrO₂, TiO₂, mullite, boehmite, Si₃N₄, SiC, AlN, etc.). The particle diameters are usually less than 10 μm, preferably less than 5 μm and more preferably less than 1 μm.

To produce ZrO₂— and Al₂O₃-based colloidal inorganic particles, the starting compounds used for the zirconium components may, for example, be one or more zirconium oxide precursors of the substance classes of zirconium alkoxides, zirconium salts or complexed zirconium compounds or colloidal ZrO₂ particles which may be unstabilized or stabilized.

The starting components for the aluminum components may, for example, be selected aluminum salts and aluminum alkoxides or nanoscale Al₂O₃ or AlOOH particles in the form of sols or powders may be used.

The solvents used for producing the ZrO₂/Al₂O₃-based binder phases may, in addition to water, also be aliphatic and alicyclic alcohols having from 1 to 8 carbon atoms (in particular methanol, ethanol, n- and i-propanol, butanol), aliphatic and alicyclic ketones (in particular acetone, butanone) having from 1 to 8 carbon atoms, esters (in particular ethyl acetate), ethers, for example diethyl ether, dibutyl ether, anisole, dioxane, tetrahydrofuran, glycol ethers such as mono-, di-, tri- and polyglycol ether, glycols such as ethylene glycol, diethylene glycol and polypropylene glycol, or other polar, protic and aprotic solvents. It will be appreciated that it is also possible to use mixtures of such solvents. In addition to water, preference is given to aliphatic alcohols (e.g. ethanol, 1-propanol, 2-propanol) and also ethylene glycol and its derivatives (in particular ethers, for example diethylene glycol monoethyl ether, diethylene glycol monobutyl ether).

Any additional inorganic fillers can be added at a wide variety of different times. For instance, these fillers can be incorporated in the course of production of the BN suspension, but they may also be added to the binder in the form of powders or suspensions.

To stabilize the oxidic particles in the liquid phase, it is possible, in addition to inorganic and organic acids, also to use modifiers which contain anhydride groups, acid amide groups, amino groups, SiOH groups, hydrolyzable radicals of silanes, and also □-dicarbonyl compounds.

Particular preference is given to monocarboxylic acids having from 1 to 24 carbon atoms, for example formic acid, acetic acid, propionic acid, butyric acid, hexanoic acid, methacrylic acid, citric acid, stearic acid, methoxyacetic acid, dioxaheptanoic acid, 3,6,9-trioxadecanoic acid, and also the corresponding acid hydrides and acid amides.

Preferred □-dicarbonyl compounds are those having from 4 to 12 carbon atoms, in particular having 5-8 carbon atoms, for example diketones such as acetylacetone, 2,4-hexanedione, acetoacetic acid, C₁₋₄-alkyl acetoacetates such as ethyl acetoacetate.

To disperse the oxidic powder particles in the binder phases, it is possible, in addition to the customary stirrer units (dissolvers, directed jet mixers), to use ultrasound treatment, kneaders, screw extruders, roll mills, vibratory mills, planetary mills, mortar mills, and in particular attritor mills.

For the dispersion of the nanoscale powders, preference is given to attritor mills with small grinding bodies, usually less than 2 mm, preferably less than 1 mm and more preferably less than 0.5 mm in diameter.

The invention further provides a process for producing a suspension comprising boron nitride particles, characterized in that boron nitride particles are suspended in an organic solvent with addition of polyvinyl butyral or of a polyacrylic acid or in water with addition of a polyvinyl alcohol or polyvinyl-pyrrolidone.

To produce the BN suspensions, preference is given to dispersing with high-speed dispersion units with rotor/stator systems, such as Ultra-Turrax or centrifugal homogenizers. Particular preference is given to units with multistage rotor/stator systems (Cavitron high-performance centrifugal homogenizer).

The inorganic release agent can be added by mixing separate BN suspensions and binders, but it may also be effected by incorporating or dispersing the BN particles in the binder. Preference is given to preparing by mixing separate BN suspensions with separate binder with stirring.

In some cases, it is advantageous, before the application of the sizes, to adjust the pH of the binder or of the size. For this purpose, a base is usually used, preferably a base in an alcoholic solvent and more preferably an ethanolic sodium ethoxide solution. The pH is usually adjusted between 1 and 7, preferably between 2.5 and 5 and more preferably between 3 and 4. The salts formed in the course of the reaction can be removed by sedimentation or centrifugation.

On completion of the size, it is advantageous in some cases to further homogenize the size before the application. This is preferably done by stirring the size overnight.

In some cases, it is also advantageous, by additions of exact amounts of water, to enable a defined hydrolysis or condensation reaction in the finished size; preference is given to establishing a total water content of less than 1 mol of water per mole of hydrolyzable alkoxide group.

Suitable substrates for the inventive mold release layers are a wide variety of different inorganic materials.

Particularly suitable substrate materials are metallic materials such as iron, chromium, copper, nickel, aluminum, titanium, tin and zinc and alloys thereof, for example cast iron, cast steel, steels, bronzes or brass, and also inorganic nonmetals such as ceramics, refractory materials and glasses in the form of films, fabrics, sheets, plaques or moldings.

The release agent-containing coating sols can be applied to the substrates/mold surfaces by means of common coating methods such as knife-coating, dipping, flow-coating, spin-coating, spraying, brushing and spreading. To improve the adhesion, it may be found to be advantageous in some cases to treat the substrate, before the contacting, with diluted or undiluted binder sols or precursors thereof or other primers.

The mold release agent covers preferably all surfaces of the diecasting molds which come into contact with the partly molten or molten metal.

The solids content of the sizes may be adjusted depending on the selected coating method by adding solvent or water. For spray coating, a solids content between 2 and 70% by weight, preferably between 5 and 50% by weight, more preferably between 10 and 30% by weight, is usually established. For other coating methods, it is of course also possible to establish another solids content. It is equally possible to add thixotropic agents or standardizers, for example cellulose derivatives.

Isostatic compaction of freshly applied release layers before the final curing can further increase the packing density and thus likewise distinctly increase the strength and the lifetime of the layer. To this end, the application of a further, virtually binder-free BN release layer is recommended, which prevents adhesion of the layer which has not yet cured with the surrounding medium in the isostatic compaction.

The final curing may be preceded by one or more drying stages at room temperature or slightly elevated temperature, for example in a forced-air drying cabinet, by heating or heat-treating the mold itself. In the case of oxidation-sensitive substrates, the drying and/or subsequent curing may be effected in a protective gas atmosphere, for example nitrogen or argon, or under reduced pressure.

The thermal curing is effected preferably by heat treatment at temperatures above 50° C., preferably above 200° C. and more preferably above 300° C.

The mold release layers can be heat-treated in an oven, by hot gas, by direct gas flaming of the mold surfaces, by direct or indirect IR heating or else in situ by contacting the mold release layers with the liquid, molten or partly molten cast metal.

The thickness of the mold release layer cured in this way is preferably from 0.5 to 250 μm, more preferably from 1 to 200 μm. Especially preferably, a layer thickness of from 5 to 20 μm is used for aluminum pressure diecasting. The BN content of the cured mold release layer is preferably in the range of 20-80%, the remainder in each case being formed by the inorganic binder comprising the nanoparticles.

### EXAMPLES

Synthesis of Silicatic Binder Sols:

### Example 1

MTKS; R_{OR} 0.4

65.5 g of MTEOS and 19.1 g of TEOS are mixed. Half of the mixture is reacted with 14.2 g of silica sol (LEVASIL 300/30) and 0.4 ml of concentrated hydrochloric acid with vigorous stirring. After 5 minutes, the second half of the silane mixture is added to the mixture which is stirred for another 5 minutes. After standing overnight, the mixture is adjusted to a pH of 3 with ethanolic sodium ethoxide solution. The salts formed in the course of the reaction are removed by centrifugation.

### Example 2

MTZS; R_{OR} 0.75

65.5 g of MTEOS and 19.1 g of TEOS are mixed. Half of the mixture is reacted with 49.7 g of zirconium dioxide suspension with solids content 60% by weight (29.82 g of monoclinic ZrO₂ (INM; mean particle size: approx. 8 nm) in 19.88 g of water) and 0.4 ml of concentrated hydrochloric acid with vigorous stirring. After 5 minutes, the second half of the silane mixture is added to the mixture which is stirred for another 5 minutes. After standing overnight, the mixture is adjusted to a pH of 3 with ethanolic sodium ethoxide solution. The salts formed in the course of the reaction are removed by centrifugation.

### Example 3

MTKZS; R_{OR} 0.75

A mixture of 16.4 g of MTEOS and 4.8 g of TEOS is reacted with 14.2 g of Levasil 300/30 which had been adjusted beforehand to a pH of 7 with concentrated hydrochloric acid, and 0.2 ml of concentrated hydrochloric acid. In parallel, a mixture of 26.2 g of MTEOS and 7.7 g of TEOS is reacted with 31.8 g of a 50% zirconium dioxide suspension (15.9 g of monoclinic ZrO₂ (INM; mean particle size: approx. 8 nm) in 15.9 g of water) and 0.32 ml of concentrated hydrochloric acid. After 10 minutes, the two mixtures are combined. After a further 5 minutes, the combined mixture with a further silane mixture consisting of 42.6 g of MTEOS and 12.4 g of TEOS is added to the mixture and stirred for another 5 minutes. After standing overnight, the mixture is adjusted to a pH of 3 with ethanolic sodium ethoxide solution. The salts formed in the course of the reaction are removed by centrifugation.

### Example 4

MTKS-PT; R_{OR} 0.4

65.5 g of MTEOS and 19.1 g of TEOS are mixed and reacted with 28.4 g of silica sol (LEVASIL 300/30) and 0.8 ml of concentrated hydrochloric acid with vigorous stirring. After 5 minutes, a further silane mixture consisting of 88.3 g of phenyltriethoxysilane (PTEOS) and 19.1 g of TEOS is added to the mixture which is stirred for another 5 minutes. After standing overnight, the mixture is adjusted to a pH of 3 with ethanolic sodium ethoxide solution. The salts formed in the course of the reaction are removed by centrifugation.

### Example 5

MTKS-PTTnP; R_{OR} 0.4

65.5 g of MTEOS and 19.1 g of TEOS are mixed and reacted with 28.4 g of silica sol (LEVASIL 300/30) and 0.8 ml of concentrated hydrochloric acid with vigorous stirring. After 5 minutes, a further silane mixture consisting of 88.3 g of phenyltriethoxysilane, 9.56 g of TEOS and 12.1 g of tetra-n-propoxysilane is added to the mixture which is stirred for another 5 minutes. After standing overnight, the mixture is adjusted to a pH of 3 with ethanolic sodium ethoxide solution. The salts formed in the course of the reaction are removed by centrifugation.

### Example 6

MTKS-PTTEE, R_{OR} 0.4

65.5 g of MTEOS and 19.1 g of TEOS are mixed and reacted with 28.4 g of silica sol (LEVASIL 300/30) and 0.8 ml of concentrated hydrochloric acid with vigorous stirring. After 5 minutes, a further silane mixture consisting of 88.3 g of phenyltriethoxysilane, 9.56 g of TEOS and 17.6 g of tetraethoxyethoxysilane is added to the mixture which is stirred for another 5 minutes. After standing overnight, the mixture is adjusted to a pH of 3 with ethanolic sodium ethoxide solution. The salts formed in the course of the reaction are removed by centrifugation.

Production of Silicatically Bonded BN Layers:

### Example 7

Preparation of Ethanolic BN Suspensions

0.8 kg of BN powder (BN E1; Wacker-Chemie GmbH, Munich) with a specific surface area, measured by the BET method, of approx. 12 m²/g and a purity of 99.0% are stirred into 1580 g of anhydrous, denatured ethanol (MEK) in which 20 g of polyvinyl butyral (Mowital B 30 T; Hoechst A G, Frankfurt) have been dissolved. The suspension is charged into a coolable stirred vessel and dispersed with a high-speed rotor/stator centrifugal homogenizer (Cavitron CD 1010) for the period of 60 min. After cooling to room temperature, the resulting suspension is diluted to a solids content of 30% by weight by adding 266.7 g of anhydrous, denatured ethanol.

### Example 8

Preparation of the BN/MTKS Size, BN:SiO₂ Mass Ratio=2:1

25 g of MTKS R_{OR} 0.4 binder are activated with 1.25 g of demineralized water and stirred for 1 h. Afterwards, 50 g of the ethanolic BN suspension from example 7 with a solids content of 30% by weight are added to the binder with stirring. In order to adjust the solids content to 15% by weight, the suspension is diluted with 75 g of ethanol.

### Example 9

Preparation of the BN/MTKS Size, BN:SiO₂ Mass Ratio=1:1

50 g of MTKS R_{OR} 0.4 binder are activated with 2.5 g of demineralized water and stirred for 1 h. Afterwards, 50 g of the ethanolic BN suspension from example 7 with a solids content of 30% by weight are added to the binder with stirring. The solids content of the size (based on BN) is 30% by weight. For better processibility, the solids content can be diluted to 15% by weight by adding 100 g of anhydrous ethanol.

### Example 10

Preparation of the BN/MTKZS Sizes, BN: (SiO₂+n-ZrO₂)=2:1

Mass Ratio of n-ZrO₂ Particles:SiO₂ Particles=20:80

21.4 g of MTKZS R_{OR} 0.75 binder are added with 50 g of the ethanolic BN suspension from example 7 with a solids content of 30% by weight with stirring. The solids content of the suspension can be diluted to 15% by weight by adding 78.6 g of ethanol.

### Example 11

Preparation of the BN/MTKS-PT; BN:SiO₂=1:1

50 g of MTKS-PT R_{OR} 0.4 are activated with 2.5 g of demineralized water and stirred for 1 h. The binder is then added with 50 g of the ethanolic BN suspension from example 7 with a solids content of 30% by weight with stirring. The solids content of the size (based on BN) is 30% by weight; it can be lowered to 15% by weight by adding 100 g of anhydrous ethanol.

Preparation of the Al₂O₃/ZrO₂ Binder Phase:

### Example 12

nAnZ Binder (1:1)

To prepare the binder phase, 100 g of boehmite (Disperal; from Sasol, Hamburg) are first stirred into 900 g of water, in the course of which a constant pH of 3 is established by gradually adding acetic acid. Addition of acetic acid establishes a pH of 3. The suspension was stirred for 24 h and the coarse agglomerates subsequently removed by sedimentation (48 h). 11.6 g of a nanodisperse, Y-stabilized, surface-modified ZrO₂ powder (INM: IZC4, specific surface areas of 200 g/cm³, 16% by weight of trioxadecanoic acid) are stirred into 128.37 g of the boehmite sol (corresponding to 10 g of Al₂O₃) and dispersed by ultrasound treatment (Branson Sonifier) for the period of 30 minutes.

### Example 13

nAZ Binder (1:1)

To prepare a ZrO₂ sol, 36.86 g of Zr n-propoxide in propanol (70% by weight) are mixed together with 16.89 g of acetic acid and 40.5 g of deionized water and stirred for 24 h (molar ratio: 1:2.5:20). 9.425 g of this sol corresponds to 1 g of ZrO₂. 28.57 g of the boehmite sol from example 12 (corresponds to 2 g of Al₂O₃) and 18.85 g of the ZrO₂ sol (corresponds to 2 g of ZrO₂) are mixed and stirred for 24 h.

Production of Al₂O₃/ZrO₂-Bonded BN Layers:

### Example 14

Preparation of an Aqueous BN Suspension

1 kg of BN powder (BN E1, Wacker-Chemie GmbH, Munich) with a specific surface area, measured by the BET method, of approx. 12 m²/g and a purity of 99.0% are stirred into 1950 g of deionized water in which 50 g of polyvinylpyrrolidone (PVP K-30, Hoechst A G, Frankfurt) have been dissolved. The suspension is charged into a coolable stirred vessel and dispersed with a high-speed rotor/stator centrifugal homogenizer (Cavitron CD 1010) for the period of 30 min. The resulting suspension is diluted to a solids content of 20% by weight by adding 2 kg of demineralized H₂O.

### Example 15

1 kg of BN powder (BN E1, Wacker-Chemie GmbH, Munich) with a specific surface area, measured by the BET method, of approx. 12 m²/g and a purity of 99.0% are stirred into 1975 g of deionized water in which 25 g of polyvinyl alcohol (PVA 4/88; Hoechst A G, Frankfurt) have been dissolved. The suspension is charged into a coolable stirred vessel and dispersed with a high-speed rotor/stator centrifugal homogenizer (Cavitron CD 1010) for the period of 30 min. The resulting suspension is diluted to a solids content of 20% by weight by adding 2 kg of demineralized H₂O.

### Example 16

Preparation of a BnAnZ Size (2:1:1)

To prepare the size, 30 g of the aqueous BN suspension from example 14, or alternatively from example 15, (corresponding to 6 g of BN) are added dropwise to 41.99 g of the above nAnZ binder phase. For better processing, a pH in the range of 4-6 can be established by adding aqueous ammonia. The size thus obtained may be applied to the substrates by means of common coating processes. After the drying, the mold release layer may be thermally compacted/cured.

### Example 17

Preparation of a BAnAnZ Size

In a first step, 80 g of Al₂O₃ (TM-DAR, from TAI MEI) in 318 g of H₂O and 2 g of acetic acid are dispersed at 700 revolutions/min in an attritor mill (PE 075 from Netzsch) with 330 g of grinding balls (Al₂O₃; diameter 4-5 mm) in a PE grinding cup (+rotor) for the period of 2 h. To prepare the size, 35 g of the above corundum suspension (corresponds to: 7 g of Al₂O₃) are first added dropwise to 70 g of the nAnZ binder sol. 15 g of the aqueous BN suspension from example 14, or alternatively from example 15, (corresponding to 3 g of BN) are added with stirring to this mixture. For better processing, a pH in the range of approx. 4-6 can be established by adding aqueous ammonia, then the size can be used for coating by means of knife-coating, casting or spraying.

### Example 18

Preparation of a BnAZ Size

28.57 g of boehmite sol (corresponding to 2 g of Al₂O₃) are stirred into 18.85 g of the ZrO₂ sol. 30 g of BN suspension from example 14, or alternatively from example 15, (corresponding to 6 g of BN) are added to this mixture with stirring. A pH in the range of approx. 4-5 can be established by adding aqueous ammonia, then the size can be used for coating by means of knife-coating, casting or spraying.

What is claimed is:

1. A size for producing a mold release layer with long-term stability, comprising
A) an inorganic binder which comprises colloidal inorganic particles based on silicon oxide, zirconium oxide or aluminum oxide or boehmite or mixtures thereof, additional inorganic fillers selected from the group comprising SiO₂, TiO₂, ZrO₂, Al₂O₃, AlOOH, Y₂O₃, CeO₂, SnO₂, iron oxides and carbon, and also optionally further additives, where
i) in the case of a binder comprising colloidal inorganic particles based on silicon oxide, the binder further comprises one or more silanes of the general formula (1):
Rₓ—Si-A₄₋ₓ (1)
in which
A are each independently hydrolytically eliminable groups selected from the group comprising hydrogen, halogens, hydroxyl groups and substituted or unsubstituted alkoxy groups having from 2 to 20 carbon atoms, aryloxy groups having from 6 to 22 carbon atoms, alkylaryloxy, acyloxy and alkylcarbonyl groups,
R are each independently hydrolytically non-eliminable groups selected from the group comprising alkyl groups having from 1 to 20 carbon atoms, alkenyl groups having from 2 to 20 carbon atoms, alkynyl groups having from 2 to 20 carbon atoms, aryl groups having from 6 to 22 carbon atoms, alkaryl and arylalkyl groups,
x is 0, 1, 2, 3, with the proviso that x≧1 for at least 50% of the amount of silanes,
and
substoichiometric amounts of water based on the hydrolyzable groups of the silane component and
optionally an organic solvent
or
ii) in the case of a binder free of colloidal inorganic particles based on silicon oxide, the binder further comprises water as a solvent
and, under the conditions of the sol-gel process, if appropriate with hydrolysis and condensation, forms a nanocomposite sol,
B) a suspension of boron nitride particles in the organic solvent in the case that the binder (i) is used, or in water in the case that the binder (ii) is used,
and
C) an organic solvent in the case that the binder (i) is used, or water in the case that the binder (ii) is used.

2. The size as claimed in claim 1, characterized in that polyvinyl butyral or a polyacrylic acid is added to the suspension of boron nitride particles in the case that the binder (i) is used, or a polyvinyl alcohol or polyvinylpyrrolidone is added to the suspension in the case that the binder (ii) is used.

3. The size as claimed in claim 1 or 2, characterized in that it has a pH of from 3 to 4.

4. The size as claimed in at least one of claims 1 to 3, characterized in that the boron nitride has a particle diameter less than 10 μm and greater than 1 μm.

5. The size as claimed in at least one of claims 1 to 4, characterized in that the boron nitride has a hexagonal, graphite-like crystal structure.

6. The size as claimed in at least one of claims 1 to 5, characterized in that the boron nitride has a specific surface area measured by the BET method of from 1 to 100 m²/g.

7. The size as claimed in at least one of claims 1 to 6, characterized in that the boron nitride has a purity of at least 98%.

8. The size as claimed in at least one of claims 1 to 7, characterized in that the boron nitride is present in the size in deagglomerated form.

9. The size as claimed in at least one of claims 1 to 8, characterized in that the additional inorganic fillers are nanoparticles which preferably have a particle diameter of less than 300 nm, preferably less than 100 nm and more preferably less than 50 nm, and are of silicon oxides or zirconium oxides or boehmite or mixtures thereof.

10. The size as claimed in at least one of claims 1 to 9, characterized in that the silanes used are methyltriethoxysilane, tetraethoxysilane or phenyltriethoxysilane or mixtures thereof.

11. The size as claimed in at least one of claims 1 to 10, characterized in that the amount of water used for hydrolysis and condensation is from 0.1 to 0.9 mol of water per mole of hydrolyzable groups present.

12. The size as claimed in at least one of claims 1 to 9, characterized in that the starting compounds used for the zirconium components for the colloidal inorganic particles are one or more zirconium oxide precursors of the substance classes of zirconium alkoxides, zirconium salts or complexed zirconium compounds or colloidal ZrO₂ particles which may be unstabilized or stabilized.

13. The size as claimed in at least one of claims 1 to 9 or 12, characterized in that the starting compounds used for the aluminum components for the colloidal inorganic particles are aluminum salts, aluminum alkoxides, nanoscale Al₂O₃ or AlOOH particles in the form of sols or powders.

14. A process for producing a size as claimed in at least one of claims 1 to 13, characterized in that boron nitride is dispersed in the solvent in a dispersion apparatus and mixed with the inorganic binder.

15. The process as claimed in claim 14, characterized in that polyvinyl butyral or a polyacrylic acid is added to the inorganic binder in the case that the binder (i) is used, or a polyvinyl alcohol or polyvinylpyrrolidone is added to the inorganic binder in the case that the binder (ii) is used.

16. The process as claimed in claim 14 or 15, characterized in that the dispersion apparatus used is an Ultra-Turrax or high-performance centrifugal homogenizer.

17. The process as claimed in at least one of claims 14 to 16, characterized in that the size has a pH of from 3 to 4.

18. A mold release layer with long-term stability, obtainable from a size as claimed in at least one of claims 1 to 13, characterized in that the layer thickness of the cured mold release layer has from 0.5 to 250 μm.

19. The mold release layer as claimed in claim 18, characterized in that the temperature for thermally attaching or compacting the mold release layer is less than 600° C.

20. The mold release layer as claimed in claim 18, characterized in that the mold release layer is obtained in situ by virtue of the metal melt.

21. The mold release layer as claimed in at least one of claims 18 to 20, characterized in that the BN content of the cured mold release layer is from 20 to 80% by weight.

22. A process for producing a mold release layer with long-term stability as claimed in at least one of claims 18 to 21, characterized in that the size as claimed in at least one of claims 1 to 11 is applied to a firmly adhering layer on metal or inorganic nonmetal surfaces.

23. The process as claimed in claim 22, characterized in that the metal or inorganic nonmetal surfaces are iron, chromium, copper, nickel, aluminum, titanium, tin and zinc and alloys thereof, cast iron, cast steel, steels, bronzes, brass, ceramics, refractory materials and glasses in the form of films, fabrics, sheets, plaques or moldings.

24. The process as claimed in claim 22 or 23, characterized in that the size is applied to the metal or inorganic nonmetal surfaces by knife-coating, dipping, flow-coating, spin-coating, spraying, brushing and spreading.

25. A process for producing a suspension containing boron nitride particles, characterized in that boron nitride particles are suspended in an organic solvent with the addition of polyvinyl butyral or of a polyacrylic acid or in water with the addition of a polyvinyl alcohol or polyvinylpyrrolidone.
